(19) United States
(12) Patent Application Publication
(10) Pub. No.: US 2001/0040953 A1
(43) Pub. Date: Nov. 15, 2001

(54) Method and system for the control of call setup in a telecommunication system

(76) Inventor: Ari Riekki, Oulu (FI)

Correspondence Address: Michael B. Lasky, Altera Law Group, 6500 City West Parkway - Suite 100, Minneapolis, MN, 55434-7701, US

(21) Appl. No.: 09/881,484

(22) Filed: Jun. 14, 2001

Related U.S. Application Data
(63) Continuation of application No. PCT/FI99/01033, filed on Dec. 14, 1999.

(30) Foreign Application Priority Data
Dec. 16, 1998 (FI) 982725

(51) Int. Cl. H04M 3/42; H04M 7/00

(52) U.S. Cl. 379/211.02; 379/207.02; 379/221.01

(57) ABSTRACT

Method for controlling call setup in a telecommunication system comprising a telephone network, a telephone exchange connected to the telephone network, a first subscriber line connected to the telephone exchange, a second subscriber line connected to the telephone exchange, a first telecommunication terminal, a second telecommunication terminal, an answering service pertaining to the B-party. From the B-subscriber line, a function for preventing normal setup of a call from the A-subscriber line is set. The A-party is given e.g. a voice menu which the A-party uses to direct the call setup to a desired destination, preferably to the B-party's telecommunication terminal or answering machine. The invention makes it possible for the B-party to set a function for his subscription that allows the A-party to make the final decision regarding the connection of a call.

The present invention relates to telecommunication. The invention concerns a method and system for the control of call setup in a telecommunication system.

### BACKGROUND OF THE INVENTION

The telephone network, especially the Public Switched Telephone Network (PSTN), was originally developed to satisfy the need for easier and faster accessibility between people. If the called party could not be reached, then the only alternative was to try again later. Since then, a considerable number of various service functions designed to increase the ease of use of the telephone and to improve the accessibility of subscribers have been developed in the public switched telephone network. At present, most of these functions are more or less implemented via an intelligent network (IN). In parallel with public switched telephone networks, various public land mobile networks (PLMN) have been developed, which allow a better accessibility as mobility is brought under control. In these networks, too, various services as mentioned above can be implemented with or without intelligent networks.

At present, services operated e.g. via a voice menu in which the caller selects a desired service from given alternatives can be easily implemented. Further, it is possible to implement a function whereby a kind of “filter” is used to determine which calls are to be connected to the subscriber and which calls are not to be connected. In practice, the implementation is such that a list of telephone numbers is defined in a network component and calls originated from these numbers are connected. This is a kind of profile service. Naturally, a plurality of different profiles can be defined for use in the profile service. This type of service is known as an intelligent network service called Terminating Call Screening, TCS.

A problem with the above-mentioned service descriptions is that, e.g. in a profile service, call setup is carried on right up to the terminal if an A-party's call attempt to a B-party is approved and thus results in the terminal ringing. In current implementations, the A-party is not given a chance at the time of call setup to choose where the call is to be finally connected. So far, the decision whether the B-party's terminal shall ring or not has always rested with the B-party, in other words, the B-party directs the calls either to another number via call transfer or to an answering machine. However, in some cases, the B-party could give information to the caller and, based on this information, the caller could decide whether he/she wants to trouble the B-party with a call.

The object of the invention is to eliminate the drawbacks referred to above or at least to significantly alleviate them. A specific object of the invention is to disclose a new type of method whereby a function preventing immediate connection of a call to the receiver is set in the terminal equipment or the telephone exchange. The object is to disclose an arrangement in which a call is directed to an answering service and further in accordance with the A-party's choice, which may be based on information given by the B-party via an answering machine, e.g. to the B-party's terminal equipment.

As for the features characteristic of the present invention, reference is made to the claims.

### BRIEF DESCRIPTION OF THE INVENTION

The method of the present invention concerns the control of call setup in a telecommunication system. The system comprises a telephone network, a telephone exchange connected to the telephone network, a first subscriber line connected to the telephone exchange, a second subscriber line connected to the telephone exchange, a first telecommunication terminal, a second telecommunication terminal and an answering service pertaining to the B-party. The answering service may be a feature incorporated in the B-party's telecommunication terminal, in the telephone exchange or in an intelligent network component. Moreover, the telephone network may comprise an intelligent network connected to the telephone network. The telephone network is primarily a public switched telephone network, but it may also be a public land mobile network.

In the method of the present invention, the A-party uses the first telecommunication terminal and the B-party uses the second telecommunication terminal. From the B-party's subscriber line, a function is set which prevents normal connection of a call to the B-party's telecommunication terminal. If necessary, the B-party's right to use this function can be verified. This function is set e.g. in the B-party's telecommunication terminal or in the telephone exchange. If necessary, the B-party may define a desired length of time during which the function is to remain in effect.

Now, when the A-party is setting up a voice connection to the B-party's subscriber line, the call setup will not proceed right up to the telecommunication terminal but is instead directed to the B-party's answering service. From the answering service, the A-party receives e.g. a voice menu and instructions on the basis of which he directs the call setup further e.g. to the B-party telecommunication terminal or answering machine. If the A-party is an ISDN subscriber (ISDN, Integrated Services Digital Network), the information may alternatively consist of a functional message or a text message. Further call control based on the information may be effected using DTMF signalling (DTMF, Dual Tone Multi-Frequency), a functional protocol or a keypad protocol.

When this function is on, the B-party can be notified of its activity. Such notice is sent e.g. when the B-party picks the receiver while the function is on. This notice may consist of a voice message or, if the B-party is an ISDN subscriber, it may also be a functional message or a text message. This notice serves to ensure that the service will not be accidentally left in the active state. Correspondingly, when the B-party switches the function off, he may receive a message giving the numbers from which calls have been made while the function has been on.

Call control according to the function of the invention is implemented e.g. using an intelligent network. Having received an instruction to set the function into active state, the telephone exchange informs the intelligent network about the function and hands call control over to the intelligent network. The intelligent network knows that the service function comprises an answering service and reception of control information from the A-party. The A-party is sent a recorded voice message or other message stored in the answering service, and based on this message, the A-party then directs the call setup to the desired destination.

The answering service comprises e.g. the following components:

a “recorder” for the playback and storage of messages,

a storage for the B-party's messages comprised in this service,

a storage for the messages left by A-parties

a storage for the B-party's normal answering machine message,

a component for identifying control information sent by the A-party and/or the B-party, and

a control component which makes the decisions and controls the service process on the basis of DTMF signalling or other corresponding information.

The system of the present invention comprises means for setting a function preventing normal setup of a call destined to a B-party's telecommunication terminal and means for directing a call received in an answering service to the B-party's telecommunication terminal or some other destination chosen by the A-party.

Furthermore, the system comprises means for preventing normal call setup during a predetermined period of time and means for notifying the B-party about the function having been set as well as means for informing the A-party about the function switched on by the B-party.

In addition, the A-party's and the B-party's terminal equipment comprises means for processing tone frequency signals and/or functional messages and/or text messages. Moreover, the telephone exchange comprises means for processing tone frequency signals.

In the system of the invention, the first and/or the second telecommunication terminal may be an ISDN telephone.

The present invention provides the advantage that the B-party can switch on the function for his subscription in order to allow his/her terminal to ring only in the most essential cases. In other words, the decision regarding final connection of the call is made by the A-party, depending on the importance of the matter at hand.

### LIST OF ILLUSTRATIONS

In the following, the invention will be described in detail by the aid of some of its embodiments, wherein

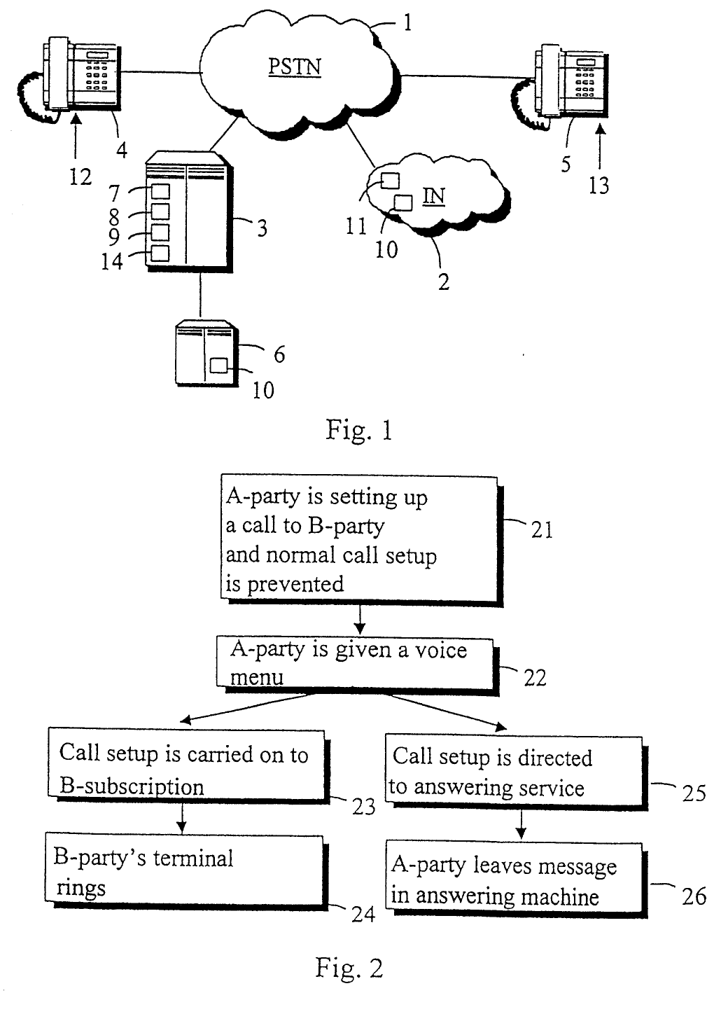

FIG. 1 presents a system according to the invention, and

FIG. 2 presents an example of a flow diagram according to the invention.

### DETAILED DESCRIPTION OF THE INVENTION

The system presented in FIG. 1 comprises a telephone network 1, an intelligent network 2 connected to the telephone network 1, a telephone exchange 3 connected to the telephone network 1, a first subscriber line connected to the telephone exchange 3, a second subscriber line connected to the telephone exchange 3, a first telecommunication terminal 4, a second telecommunication terminal 5 and an answering service 6 pertaining to the B-party.

The telephone network may be a PSTN, land mobile or ISDN network. In this description, only elements important in respect of the invention are presented, but it is to be understood that the telephone network consists of a plurality of exchanges, subscribers and so on. The subscribers may also be ISDN subscribers, in which case they are connected to the ISDN network e.g. via a basic-rate interface 2B+D. The A-party's telecommunication terminal 4 and the B-party's telecommunication terminal 5 comprise means 12 and 13 for processing tone frequency signals and/or functional messages and/or text messages. The system comprises means for setting a function preventing normal setup of a call destined to the B-party's telecommunication terminal 4 and means 8 for directing' a call received by the answering service 6 to the B-party's telecommunication terminal 4 or to some other destination chosen by the A-party.

Further, the system comprises means 9 for preventing normal call setup during a predetermined period of time, means 10 for notifying the B-party about the function having been set as well as means for informing the A-party about the function switched on by the B-party.

According to the present invention, the telephone exchange 3 comprises means 14 for processing tone frequency signals. The first telecommunication terminal 4 and/or the second telecommunication terminal 5 may be an ISDN telephone or a normal telephone in a public switched telephone network.

The telephone exchange 3 further comprises means 8 for processing tone frequency signals and/or functional messages and/or text messages. In this example, the answering service 6 is incorporated in the telephone exchange 3.

Means 7-14 are implemented in a manner known in itself, e.g. using program blocks by means of a computer, and they are therefore not described in detail.

In a preferred embodiment of the invention as illustrated in FIG. 1, the B-party wants to set for his subscriber line a function preventing normal call setup. The B-party first enters e.g. the string *52# via his telecommunication terminal. The string may include parameters relating to the service, such as duration or starting time of the service. Other ways may also be used to set a desired service into an active state. The telephone exchange receives the string and, as a result of an analysis, recognizes that the string signifies activation of a certain service.

After this, the exchange may carry out a check in a subscriber database located in the exchange to establish whether the subscriber has the right to use the service. If so, then the exchange makes a mark in the subscriber database to indicate that the service has been activated. The subscriber database in the exchange may contain e.g. subscriber numbers, various information regarding the type of the subscriber connection, and subscriber-specific information regarding services adopted and an indication of whether the services have been activated or not.

In this example, the service itself is implemented using e.g. an intelligent network, but it can also be implemented only in the exchange. When the service is started, the exchange sends a service request to the intelligent network components. The intelligent network knows the activation code corresponding to each service. In this example, the service comprises an answering service and reception of corresponding control information.

When setting the service, the B-party may decide about its duration. The duration is defined e.g. as one hour from the time of setting of the service. The service may also be continuously on for an indefinite length of time until it is deactivated. When the service is in an active state, the B-party is informed about the service e.g. with a voice message, a signal tone or message heard when the handset is picked up or, in the case of an ISDN subscriber, a text on the display of the telephone or a functional message each time when the handset is picked up. Such a feature ensures that the service will not be accidentally left in the active state.

When an A-party calls a B-party while the service is active, the call is not connected to the B-party's telecommunication terminal. The subscriber database in the exchange contains information indicating that the B-party has activated the service. At the start of the call setup procedure, the exchange analyzes the B-party's number and checks the subscriber database for data affecting the call. When it is discovered that the B-party has activated the service, actual call control is handed over to the intelligent network. The intelligent network has information indicating that the service to be provided comprises an answering service and the reception of control commands from the A-party. First, a message recorded by the B-party is played back, e.g. a voice message like: “We are just putting little Tommy to bed, so please choose a suitable alternative from the voice menu”. The message received by the A-party may also be alternatively e.g. a text message or functional message sent from the exchange or an UUS complementary service (UUS, User to User Service) if the A-party is an ISDN subscriber. The message may also be a standard message given by the operator, so its not necessarily a message set by the B-party himself. After this, the intelligent network switches on the reception of control characters from the A-party. Based on the A-party's selection, the call is directed further.

The alternatives presented to the A-party in the message include e.g. the following:

in a first alternative, the call is connected to the B-party' telecommunication terminal, so the B-party's telephone will ring

in a second alternative, the A-party leaves a message in the B-party's answering machine,

in a third alternative, the call is terminated,

in a fourth alternative, a callback service (CCBS, Call Completion to Busy Subscriber) is activated, and

in a fifth alternative, call setup is directed to a predetermined third number.

When the B-party wants to deactivate the service, he will pick up the handset and enter e.g. the string *53#. Other methods can also be used to deactivate the service. Analyzing the signal, the exchange recognizes that this string signifies deactivation of a given service. The exchange checks the information in the subscriber database to determine whether the B-party has a right to use the service, and when the access rights are in order, it adds to the database an indication of deactivation of the service. In conjunction with the deactivation of the service, it is possible to implement a function by means of which the B-party can get information about events which have taken place during the active time of the service. Using e.g. a voice or text message, the exchange may give the B-party the numbers from which call attempts have been made during the active period.

FIG. 2 presents the events in the previous example in the form of a flow diagram. The A-party is trying to set up a voice connection with the B-party. However, the B-party has set from his subscriber line a function preventing normal call setup, block 21. Consequently, the call setup procedure is not carried on until the B-party's telecommunication terminal sounds a ringing tone. The A-party is presented a voice menu, block 22, on the basis of which he directs the call setup to a desired destination. In this example, the A-party can choose between a normal call setup process which results in the B-party's telecommunication terminal ringing, block 23, in which case the B-party's telecommunication terminal rings, block 24, and a call setup process carried on to the B-party's answering service, block 25, in which case the A-party leaves a message in the answering machine, block 26.

The invention is not restricted to the examples of its embodiments described above, but many variations are possible within the scope of the inventive idea defined in the claims.

1. Method for controlling call setup in a telecommunication system comprising a telephone network (1), a telephone exchange (3) connected to the telephone network (1), a first subscriber line connected to the telephone exchange (3), a second subscriber line connected to the telephone exchange (3), a first telecommunication terminal (4), a second telecommunication terminal (5), an answering service (6) pertaining to the B-party, in which method the first telecommunication terminal (4) is used by the A-party and the second telecommunication terminal (5) is used by the B-party, characterized in that the method comprises the steps of
setting from the B-subscriber line a function preventing normal connection of a call to the B-party's telecommunication terminal (5); and
directing by means of the A-party's telecommunication terminal (4) a call received in the answering service (6) to the B-party's telecommunication terminal (5) or some other destination chosen by the A-party.

2. Method as defined in claim 1, characterized in that
an intelligent network (2) is connected to the telephone network, and
call setup is controlled via the intelligent network (2).

3. Method as defined in claims 1 and 2, characterized in that normal call setup is prevented during a predetermined period of time.

4. Method as defined in claims 1-3, characterized in that the B-party is informed about the function having been set.

5. Method as defined in claims 1-4, characterized in that the function and the setting of it are controlled via the B-party's telecommunication terminal (5) using DTMF signalling and/or a functional protocol and/or a text message.

6. Method as defined in claims 1-5, characterized in that the A-party is informed about the function switched on by the B-party, using a voice menu and/or a functional message and/or a text message.

7. Method as defined in claims 1-6, characterized in that, when the function is deactivated, the B-party is given information regarding parties having called during the service, using a voice menu and/or a functional message and/or a text message.

8. Method as defined in claims 1-7, characterized in that the B-party's right to switch on the service is verified.

9. Method as defined in claims 1-8, characterizedin that a call received by the answering service (6) is controlled by means of the A-party's telecommunication terminal using DTMF signalling and/or a functional protocol and/or a keypad protocol.

10. Method as defined in claims 1-9, characterizedin that the function preventing normal call setup is set in the telephone exchange (3) or in the B-party's telecommunication terminal (5).

11. System for controlling call setup in a telecommunication system comprising a telephone network (1), a telephone exchange (3) connected to the telephone network (1), a first subscriber line connected to the telephone exchange (3), a second subscriber line connected to the telephone exchange (3), a first telecommunication terminal (4), a second telecommunication terminal (5), an answering service (6) pertaining to the B-party, in which system the first telecommunication terminal (4) is used by the A-party and the second telecommunication terminal (5) is used by the B-party, characterizedin that the system comprises
means (7) for setting a function preventing normal setup of a call addressed to the B-party's telecommunication terminal (5); and
means (8) for directing a call received in the answering service (6) to the B-party's telecommunication terminal (5) or some other destination chosen by the A-party.

12. System as defined in claim 11, c h a r ac t e r i z e d in that the system comprises means (9) for preventing normal call setup during a predetermined period of time.

13. System as defined in claims 11 and 12, characterizedin that the system comprises means (10) for informing the B-party about the function having been set.

14. System as defined in claims 11-13, characterizedin that the system comprises means (11) for informing the A-party about the function switched on by the B-party.

15. System as defined in claims 11-14, characterizedin that the A-party's telecommunication terminal (4) comprises means (12) and the B-party's telecommunication terminal (5) comprises means (13) for processing tone frequency signals and/or functional messages and/or text messages.

16. System as defined in claims 11-15, characterizedin that the telephone exchange (3) comprises means (14) for processing tone frequency signals and/or functional messages and/or text messages.

17. System as defined in claims 11-16, characterizedin that the first telecommunication terminal (4) and/or the second telecommunication terminal (5) is an ISDN telephone or a normal telephone in a public switched telephone network.

18. System as defined in claims 11-17, characterizedin that the system comprises an intelligent network (2) connected to the telephone network (1).

19. System as defined in claims 11-18, characterizedin that the answering service (6) is a property of the B-party's telecommunication terminal (5) and/or telephone exchange (3) and/or a component in the intelligent network (2).
